(19) United States
(12) Patent Application Publication
(10) Pub. No.: US 2001/0019708 A1
(43) Pub. Date: Sep. 6, 2001

(54) Loop-type reactor column

(76) Inventor: Markus Burgert, Giessen (DE)

Correspondence Address: FLYNN, THIEL, BOUTELL & TANIS, P.C., 2026 Rambling Road, Kalamazoo, MI, 49008-1699, US

(21) Appl. No.: 09/731,893

(22) Filed: Mar. 20, 2001

(30) Foreign Application Priority Data
Dec. 8, 1999 (DE) 299 21 445.1

(51) Int. Cl. B01J 19/18; B01F 5/10; B01F 13/04

(52) U.S. Cl. 422/229; 422/224

(57) ABSTRACT

A loop-type reactor column comprising a reactor column housing, comprising a mixing chamber and an inlet in the area of the floor of the loop-type reactor column. The loop-type reactor column has an outlet in the area of the head end of the loop-type reactor column. A stator and a rotor driven by a motor. The stator and rotor each have at least one hollow cylinder provided with longitudinal slots, the hollow cylinders of the stator and the ones of the rotor being interleaved with one another concentrically and alternately. The stator has a guide tube extending into the mixing chamber in which is arranged a conveyor worm. The conveyor worm and the rotor are fastened on a common shaft driven by the motor.

### FIELD OF THE INVENTION

A loop-type reactor column comprising a reactor column housing, comprising a mixing chamber and an inlet in the area of the floor of the loop-type reactor column, and an outlet in the area of a head end of the loop-type reactor column for the material to be processed, comprising a stator and a rotor driven by a motor, whereby stator and rotor are mostly arranged in the portion of the mixing chamber facing the second head, stator and rotor have each at least one hollow cylinder provided with longitudinal slots, the hollow cylinders of the stator and the ones of the rotor are interleaved with one another concentrically and alternately, and the stator has a guide tube extending into the mixing chamber, in which guide tube is arranged a conveyor worm.

### BACKGROUND OF THE INVENTION

Such a loop-type reactor column is known from the DE 39 19 828 and is used to process liquids of varying viscosity. Such loop-type reactor columns are of great importance in particular in the area of food processing, for example for mixing, emulsifying, homogenizing, suspending, adding, stirring smooth, drawing under, etc., of liquids and, if necessary, solids to be processed. In the loop-type reactor columns with a conveyer worm provided for the transport of the material (also known as a dynamic mixer), the material is thereby processed by the rotating hollow cylinders of the rotor and of the stator. These slotted hollow cylinders cause, for example, a reduction in size of drops during emulsions.

The conveyor worm is, in conventional loop-type reactor columns with conveyor worms driven by its own shaft, separate from the rotor. This requires passages for the shafts on each of the two end faces of the reactor column housing. Motors must then be mounted on the outside of the reactor column housing to drive the shafts. This design of the loop-type reactor column and also the installation of such a loop-type reactor column is expensive. The parts of the rotor and of the conveyor worm, which parts rotate separately from one another, also increase the susceptibility to breakdown of the loop-type reactor column. Also the operation of a motor, one for the rotor and one for the conveyor worm is related to increased costs.

Furthermore, loop-type reactor columns are known in which rotor and conveyor worm are fastened on a common shaft. The shaft is in these loop-type reactor columns guided through the floor of the reactor column and is supported outside of the reactor column housing. A large distance between the hollow cylinders of the rotor and of the stator on the one hand and the bearing on the other hand results thereby. This is disadvantageous since the largest forces and moments acting onto the shaft occur in the area of the hollow cylinders, thus at the unsupported free end of the shaft, which in particular in the case of high speeds results in problems. Help was found in a further bearing in the area of the hollow cylinders which, however, resulted in problems during cleaning of the mixing chamber.

### SUMMARY OF THE INVENTION

The basic purpose of the invention is therefore to provide a loop-type reactor column which is simpler in design, and easier to install, and is less susceptible to breakdown during operation, and is less expensive and can be operated also at high speeds.

This purpose is attained according to the invention by the conveyor worm and the rotor being fastened on a common shaft driven by a motor, and by the shaft being guided through the head end of the loop-type reactor column and being rotatably supported in the head end and/or above the head end.

With this arrangement of rotor and conveyor worm, it is possible to not only eliminate a second motor, but also the design and installation of the loop-type reactor column is simpler. Thus, it is now merely necessary to provide an opening and a bearing for the shaft, on which then both the rotor and also the conveyor worm are fastened. This bearing is thereby to be provided in the head end so that the forces occurring in the shaft can be discharged near the point of creation from the shaft into the reactor column housing. Namely, the largest forces and moments, which act onto the shaft, occur in the rotor and same is arranged in the portion of the mixing chamber facing the head end.

The inlet is according to the invention provided in the floor of the loop-type reactor column, whereby advantageously the guide tube for the conveyor worm terminates in the area of this inlet.

The bearing of the shaft can according to the invention be sealed off in or rather at the head end with respect to hollow chambers in the reactor column housing which house the material to be processed. The seal can advantageously be a slide ring packing.

The inlet, the guide tube, the rotor, and the stator, and also sheet-metal guides fastened on the stator can according to the invention be centrally arranged.

### BRIEF DESCRIPTION OF THE DRAWINGS

One exemplary embodiment of a loop-type reactor column is described in greater detail in connection with the drawings, in which:

FIG. 1 is a vertical cross-sectional view of a loop-type reactor column,

FIG. 2 is a horizontal cross-sectional view taken along the line II-II of FIG. 1, and

FIG. 3 is a vertical cross-sectional view taken along the lines III-III of FIG. 1.

### DETAILED DESCRIPTION

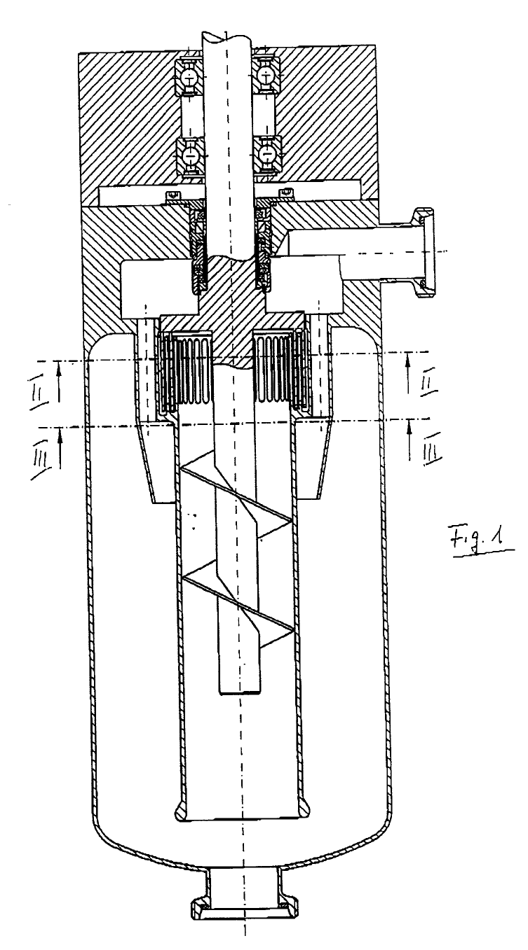

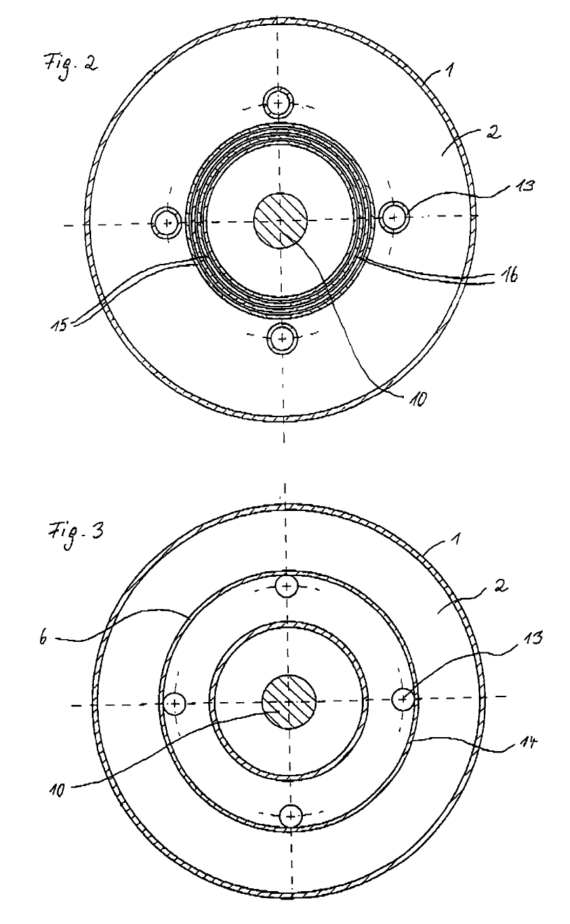

A loop-type reactor column (FIG. 1) has a reactor column housing 1 with a mixing chamber 2. The material to be processed can enter the mixing chamber 2 of the loop-type reactor column through an inlet 3 or can exit from the mixing chamber 2 through an outlet 4. The mixing chamber 2 itself has a cylindrical shape, and the inlet 3 is provided in the floor of the loop-type reactor column. A stator 5 projects into the mixing chamber 2, which stator is fixedly connected to the reactor column housing. The stator 5 has two hollow cylinders 15, the cylinder walls of which have longitudinal slots 9. The stator 5 is furthermore provided with a guide tube 6 which extends almost over the entire length of the mixing chamber 2. A shaft 10 projects into this guide tube as well as is guided through the head end of the reactor column housing remote from the inlet 3 to the exterior reactor column housing 1. The shaft is thereby rotatably supported in the bearings 11 provided above the head. A rotor 8 is fastened to the shaft 10. This rotor has two hollow cylinders 16, which have longitudinal slots 9 just like the hollow cylinders 15 of the stator. The hollow cylinders 15 of the stator and rotor 16 are, alternately interleaved and concentrically arranged with respect to one another (see also FIG. 2). Furthermore a conveyor worm 7 is fastened to the end of the shaft 10 which projects into the guide tube 6. A front storage chamber 17 is created on the outside of the stator or of the guide tube 6 by means of a sheet-metal guide 14 (see also FIG. 3). This front storage chamber 17 is ringlike and open over the entire circumference in direction of the inlet 3 of the loop-type reactor column. Plural holes are provided in the upper wall of the front storage chamber 17 into each of which hollow tubes 13 are received and attached. These tubes 13 connect the front storage chamber 17 to a rear storage chamber 12 provided in the head end of the reactor column housing 1. This rear storage chamber 12 opens into the outlet 4 of the loop-type reactor column.

The path of the material to be processed through the loop-type reactor column and the operation of the loop-type reactor column will be described hereinafter. The material to be processed enters through the inlet 3 in the reactor column housing 1 into the loop-type reactor column. It thereby reaches first due to the conveyor pressure into the guide tube 6. It is there picked up by the conveyor worm 7 and is transported upwardly. The upper end of the guide tube 6 transfers over into a first hollow cylinder 15 of the stator. Since the guide tube 6 is upwardly limited by the rotor 8, the material is pressed by the feed pressure through the longitudinal slots 9 in the hollow cylinder 15 of the stator. A first hollow cylinder 16 of the rotor 8 rotates on the outside of the longitudinal slots 9. The material exiting from the hollow cylinder 15 is cut off through the longitudinal slots 9 provided in this rotor, and is comminuted, emulsified or the like. The same is happening on the outside of the longitudinal slots in the first rotor hollow cylinder 16 since these hollow cylinders 16 in turn are followed by a hollow cylinder 15 of the stator 5. After the material has been pressed through this hollow cylinder 15 of the stator 5, a further hollow cylinder 16 of the rotor 8 and a last hollow cylinder 15 of the stator 5, the material moves back into the free space of the mixing chamber 2 between the guide tube 6 and the reactor column housing 1. Due to the existing feed pressure, the material between the guide tube 6 and the reactor column housing 1 is again fed back in direction of the inlet 3. It there again enters into the guide tube 6 due to the suction of the feed flow and travels the same path. A portion of the material, however, enters through the space opening in direction of the inlet 3 into the front storage chamber 17 provided behind the sheet-metal guide 14. From there it is moved through the tubes 13 into the rear storage chamber 12. When sufficient material has been collected there, same can finally again exit through the outlet 4 from the loop-type reactor column.

What is claimed is:

1. A loop-type reactor column comprising a reactor column housing, comprising a mixing chamber and an inlet in the area of the floor of the loop-type reactor column, and an outlet in the area of a head end of the loop-type reactor column for the material to be processed, comprising a stator and a rotor driven by a motor, whereby stator and rotor are mostly arranged in the portion of the mixing chamber facing the second head, stator and rotor each have at least one hollow cylinder provided with longitudinal slots, the hollow cylinders of the stator and the ones of the rotor are alternately interleaved and concentrically arranged, and the stator has a guide tube projecting into the mixing chamber, in which guide tube is arranged a conveyor worm, wherein the conveyor worm and the rotor are fastened on a common shaft driven by a motor, and wherein the shaft is guided through the second head of the loop-type reactor column and is rotatably supported in the head end and/or above the head end.

2. The loop-type reactor column according to claim 1, wherein the guide tube for the conveyor worm terminates in the area of the inlet.

3. The loop-type reactor column according to claim 1, wherein the bearing of the shaft is sealed off in or on the head end remote from the hollow chambers in the reactor column housing, which hollow chambers house the material to be processed.

4. The loop-type reactor column according to claim 3, wherein the seal is a slide ring packing.

5. The loop-type reactor according to claim 1, wherein the inlet, the guide tube, the rotor, and the stator, and also sheet-metal guides fastened on the stator are arranged centrally in the mixing chamber.
